(19) United States
(12) Patent Application Publication
(10) Pub. No.: US 2007/0103714 A1
(43) Pub. Date: May 10, 2007

(54) INFORMATION PROCESSING APPARATUS, PRINTING APPARATUS, CONTROL METHOD THEREOF, AND PRINTING SYSTEM

(75) Inventor: Toru USHIKU, Ohta-ku, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/553,579

(22) Filed: Oct. 27, 2006

(30) Foreign Application Priority Data
Nov. 4, 2005 (JP) 2005-321396

(51) Int. Cl. G06K 15/00

(52) U.S. Cl. 358/1.14; 358/1.15

(57) ABSTRACT

This invention provides an information processing apparatus which can efficiently and easily execute print processing to which print settings set for different levels for identical document data are applied, a printing apparatus, a control method thereof, and a printing system. A plurality of pieces of print setting information corresponding to a plurality of different user levels are set for identical document data. Print data are generated based on the set plurality of pieces of print setting information corresponding to the plurality of different user levels and the document data. The generated print data are output to a printing apparatus.

### BACKGROUND OF THE INVENTION

1. Field of the Invention

The present invention relates to a printing system having an information processing apparatus for generating print data and a printing apparatus for executing print processing based on the print data, the information processing apparatus, the printing apparatus, and a control method thereof.

2. Description of the Related Art

Document data created in an office or the like often includes confidential information. Upon distributing this document data, when that confidential information is not to be seen, a technique for executing print processing excluding the confidential information is available. When the confidential information is not to be copied, a technique for printing a copy suppression image such as a copy-forgery-inhibited-pattern-image or the like in addition to the document data to suppress copying is available.

With the presence of these techniques, for example, Japanese Patent Laid-Open No. 2003-32484 describes a technique for switching processing for print data input to a printer in accordance with the security level of that data.

However, in order to make print control in correspondence with a distribution condition in this way, document data must be changed or print settings must be made every time print processing is executed, thus imposing a load on the user. Since a setting item which can be set in the technique of Japanese Patent Laid-Open No. 2003-32484 is a security level for the entire print data, a security level cannot be individually set for each page. For this reason, it is impossible to inhibit print processing of some pages of print data from being inhibited or to suppress their copying. In this manner, print contents of respective pages in print data cannot be adaptively controlled in accordance with the security levels of pages.

### SUMMARY OF THE INVENTION

The present invention has been made to solve the aforementioned problems, and has as its object to provide an information processing apparatus that can efficiently and easily execute print processing to which print settings set for different levels for identical document data are applied, a printing apparatus, a control method thereof, and a printing system.

According to the present invention, the foregoing object is attained by providing an information processing apparatus for generating print data to be output to a printing apparatus, comprising:

setting means for setting a plurality of pieces of print setting information corresponding to a plurality of user types for identical document data;

generation means for generating a print job which includes the plurality of pieces of print setting information corresponding to the plurality of user types set by the setting means and print data based on the document data; and

output means for outputting the print job generated by the generation means so as to print it using the printing apparatus.

In a preferred embodiment, the generation means generates a print job which includes print data corresponding to the plurality of user types obtained by applying the plurality of pieces of print setting information corresponding to the plurality of user types set by the setting means to the document data.

In a preferred embodiment, the setting means comprises:

first setting means for setting groups to which pages that form the document data belong;

second setting means for setting processing contents of pages that belong to the groups set by the first setting means in correspondence with the plurality of user types; and

third setting means for setting the numbers of copies to be printed of the document data according to the processing contents set for the user types in correspondence with the plurality of user types.

In a preferred embodiment, the apparatus further comprises display control means for controlling to display a print setting dialog including the first to third setting means on a display unit.

In a preferred embodiment, the processing contents include a print method of one of a normal print mode, a copy-forgery-inhibited-pattern print mode, and a print inhibition mode, and the number of copies to be printed corresponding to each user type.

According to the present invention, the foregoing object is attained by providing a printing apparatus for executing print processing based on print data received from an information processing apparatus, comprising:

reception means for receiving, from the information processing apparatus, print data in which a plurality of pieces of print setting information are set in correspondence with a plurality of user types; and

print control means for controlling to execute print processing in accordance with the print setting information set in the print data received by the reception means.

In a preferred embodiment, the print data includes print data corresponding to the plurality of user types obtained by applying the plurality of pieces of print setting information to identical document data.

In a preferred embodiment, the print control means controls to execute the print processing of the processing contents corresponding to each of the plurality of user types in accordance with the print setting information set in the print data received by the reception means.

In a preferred embodiment, the apparatus further comprises:

input means for inputting identification information required to identify a user who operates the printing apparatus;

storage means for storing the print data without executing print processing until the identification information is input from the input means; and

determination means for determining a security level of the user based on the identification information input by the input means, and

in that the print control means executes, in accordance with the print setting information of the user type corresponding to the security level determined by the determination means of the plurality of pieces of print setting information set in the print data stored in the storage means, the print processing of the processing contents corresponding to the user type.

According to the present invention, the foregoing object is attained by providing a printing system having an information processing apparatus for generating print data, and a printing apparatus for executing print processing based on the print data, wherein

setting means for setting a plurality of pieces of print setting information corresponding to a plurality of user types for identical document data;

generation means for generating a print job which includes the plurality of pieces of print setting information corresponding to the plurality of user types set by the setting means and print data based on the document data; and

output means for outputting the print job generated by the generation means so as to print it using the printing apparatus, and

the printing apparatus comprises:

reception means for receiving, from the information processing apparatus, the print data in which the plurality of pieces of print setting information are set in correspondence with the plurality of user types; and

print control means for controlling to execute print processing in accordance with the print setting information set in the print data received by the reception means.

According to the present invention, the foregoing object is attained by providing a method of controlling an information processing apparatus for generating print data to be output to a printing apparatus, comprising:

a setting step of setting a plurality of pieces of print setting information corresponding to a plurality of user types for identical document data;

a generation step of generating a print job which includes the plurality of pieces of print setting information corresponding to the plurality of user types set in the setting step and print data based on the document data; and

an output step of outputting the print job generated in the generation step so as to print it using the printing apparatus.

According to the present invention, the foregoing object is attained by providing a method of controlling a printing apparatus for executing print processing based on print data received from an information processing apparatus, comprising:

a reception step of receiving, from the information processing apparatus, print data in which a plurality of pieces of print setting information are set in correspondence with a plurality of user types; and

a print control step of controlling to execute print processing in accordance with the print setting information set in the print data received in the reception step.

According to the present invention, the foregoing object is attained by providing a program stored in a computer-readable memory, for making a computer control an information processing apparatus for generating print data to be output to a printing apparatus, the program making the computer execute:

a setting step of setting a plurality of pieces of print setting information corresponding to a plurality of user types for identical document data;

a generation step of generating a print job which includes the plurality of pieces of print setting information corresponding to the plurality of user types set in the setting step and print data based on the document data; and

an output step of outputting the print job generated in the generation step so as to be printed using the printing apparatus.

According to the present invention, the foregoing object is attained by providing a program stored in a computer-readable memory, for making a computer control a printing apparatus for executing print processing based on print data received from an information processing apparatus, the program characterized by making the computer execute:

a reception step of receiving, from the information processing apparatus, print data in which a plurality of pieces of print setting information are set in correspondence with a plurality of user types; and

a print control step of controlling to execute print processing in accordance with the print setting information set in the print data received in the reception step.

Further features of the present invention will become apparent from the following description of exemplary embodiments with reference to the attached drawings.

### BRIEF DESCRIPTION OF THE DRAWINGS

FIG. 1 is a diagram showing the arrangement of a printing system according to the first embodiment of the present invention;

FIG. 2 is a sectional view showing the structure of a printing apparatus according to the first embodiment of the present invention;

FIG. 3 is a block diagram showing the internal arrangement of principal part of an MFP according to the first embodiment of the present invention;

FIG. 4A is a block diagram showing the arrangement of a host computer according to the first embodiment of the present invention;

FIG. 4B is a block diagram showing the principal functional arrangement of the host computer according to the first embodiment of the present invention;

FIG. 4C is a block diagram showing an enhancement example of the principal functional arrangement of the host computer according to the first embodiment of the present invention;

FIG. 5A shows an example of a print setting dialog according to the first embodiment of the present invention;

FIG. 5B shows an example of a print setting dialog according to the first embodiment of the present invention;

FIG. 5C shows an example of a print setting dialog according to the first embodiment of the present invention;

FIG. 5D shows an example of a print setting dialog according to the first embodiment of the present invention;

FIG. 6 shows a configuration example of document data according to the first embodiment of the present invention;

FIG. 7 is a flowchart showing print setting processing executed by the host computer according to the first embodiment of the present invention;

FIG. 8 shows an example of print data according to the first embodiment of the present invention;

FIG. 9 is a flowchart showing print processing executed by the MFP according to the first embodiment of the present invention;

FIG. 10 shows an output result example according to the first embodiment of the present invention;

FIG. 11 shows an example of a security management table according to the second embodiment of the present invention;

FIG. 12 shows an example of a control panel according to the second embodiment of the present invention;

FIG. 13 shows an example of a key input unit according to the second embodiment of the present invention;

FIG. 14 shows an example of a touch panel unit according to the second embodiment of the present invention;

FIG. 15 shows an example of a job status dialog according to the second embodiment of the present invention; and

FIG. 16 shows an example of print data according to the third embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

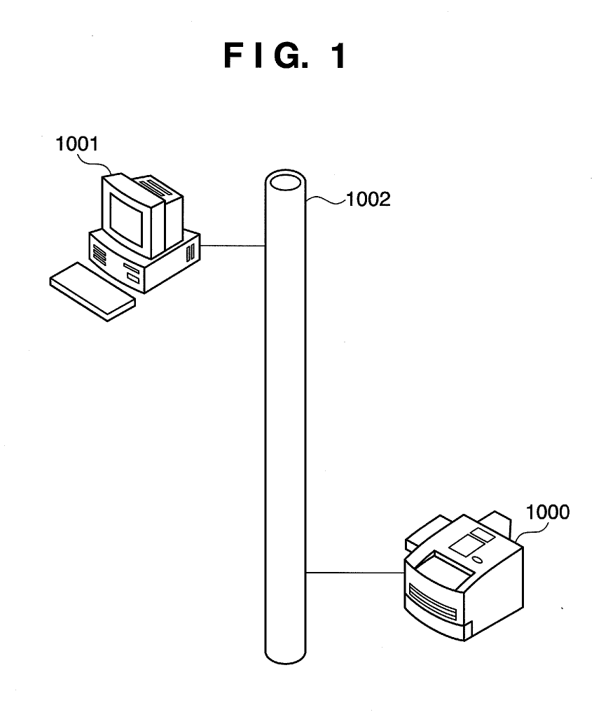

FIG. 1 is a diagram showing the arrangement of a printing system according to the first embodiment of the present invention.

The printing system shown in FIG. 1 is configured by connecting an MFP (printing apparatus) 1000 and a host computer 1001 via a predetermined network (LAN or the like) that allows communications. In the first embodiment, the host computer 1001 can output print data (e.g., various PDL (page description language) data such as PDF, PS, etc.) generated by itself to the MFP 1000 via the network 1002 and can print it out.

Note that the MFP 1000 and host computer 1001 need not be connected via the network 1002, and they may be directly connected via a predetermined interface (e.g., a USB interface).

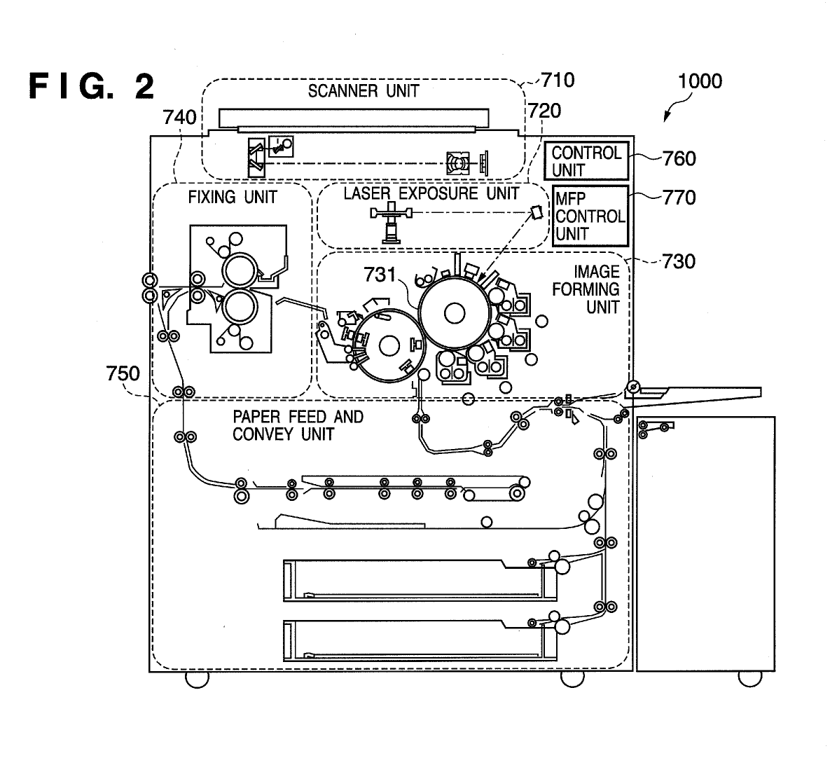

The arrangement of the MFP (Multi Function Peripheral) as the printing apparatus suitably applied to the first embodiment will be described below with reference to FIG. 2.

Note that the printing apparatus to be applied to the first embodiment is not limited to the MFP, and printing apparatuses of other print systems such as a laser beam printer, ink-jet printer, and the like may be applied.

Note that the MFP comprises a storage device such as a hard disk or the like, which can store a plurality of jobs in itself. Also, the MFP comprises a copy function that allows to print a job output from a scanner unit using a printer unit via the storage device. Furthermore, the MFP comprises a print function that allows to print a job output from an external apparatus such as a PC (personal computer) or the like using the printer unit via the storage device. In this manner, the MFP comprises a plurality of functions including these functions.

The MFP includes a full-color machine and monochrome machine. The full-color machine normally includes components of the monochrome machine in a basic part except for a color processing function and internal data. For this reason, the following explanation will focus on the full-color machine, and a description of the monochrome machine will be added as needed.

The printing system described in the first embodiment may comprise a multi-function type image forming apparatus (printing apparatus) having a plurality of functions, and an SFP as a single-function type image forming apparatus (printing apparatus) having a print function alone. Also, the printing system may comprise a plurality of image forming apparatuses independently of their types. In any case, the arrangement of the printing system is not particularly limited as long as the control of the first embodiment can be implemented.

Note that the SFP is a short for a Single Function Peripheral.

FIG. 2 is a sectional view showing the structure of the printing apparatus according to the first embodiment of the present invention. FIG. 2 shows an example of the structure of, e.g., a color MFP.

A color MFP 1000 which serves as a printing apparatus comprises a scanner unit (document exposure unit) 710, a laser exposure unit 720, an image forming unit 730 having a photosensitive drum 731, a fixing unit 740, and a paper feed and convey unit 750 as its principal components. Furthermore, the MFP 1000 comprises a control unit 760 for controlling these components.

The scanner unit 710 optically scans a document image by irradiating a document placed on a document table with light, and generates image data by converting the scanned image into an electrical signal.

The laser exposure unit 720 irradiates a rotary polygonal mirror (polygon mirror) which rotates at an equal angular velocity with a beam such as a laser beam or the like modulated according to the image data generated by the scanner unit 710, and irradiates the photosensitive drum 731 with a reflected scan beam.

The image forming unit 730 rotates the photosensitive drum 731, charges it by a charger, and visualizes a latent image formed on the photosensitive drum 731 by the laser exposure unit 720 with toner. The image forming unit 730 transfers the toner image onto a sheet (print sheet), and recovers a minute amount of residual toner on the photosensitive drum 731. In this way, the image forming unit 730 forms an image by repeating a series of such electrophotography processes.

In this case, developing units respectively having magenta (M), cyan (C), yellow (Y), and black (K) toners alternately repeat the electrophotography processes during four revolutions of a transfer belt around which a sheet is wound at a predetermined position. After the four revolutions, the sheet on which a full-color (four-color) toner image is transferred leaves the transfer drum, and is conveyed to the fixing unit 740.

The fixing unit 740 comprises a combination of rollers and a belt, and incorporates a heat source such as a halogen heater or the like. The fixing unit 740 melts and fixes the toner on the sheet on which the toner image is transferred by the image forming unit 730 by heat and pressure.

The paper feed and convey unit 750 has one or more sheet storages represented by a sheet cassette and paper deck, separates one sheet from a plurality of sheets stored in each sheet storage in accordance with an instruction from the control unit 760, and sequentially conveys it to the image forming unit 730 and fixing unit 740. The conveyed sheet is wound around the transfer drum of the image forming unit 730. After the four revolutions of the transfer drum, the sheet is conveyed to the fixing unit 740. During the four revolutions, the aforementioned Y, M, C, and K toner images are transferred onto the sheet. When images are to be formed on the two surfaces of the sheet, the sheet which has passed the fixing unit 740 is controlled to pass through a convey path that conveys it to the image forming unit 730 again.

The control unit 760 communicates with an MFP control unit 770 that controls the overall MFP 1000 to execute control according to instructions from the MFP control unit 770. In addition, the control unit 760 instructs the scanner unit 710, laser exposure unit 720, image forming unit 730, fixing unit 740, and paper feed and convey unit 750 so that all these units can operate smoothly in coordination, while managing the states of these units.

Note that the positions indicating the control unit 760 and MFP control unit 770 in FIG. 2 are not their physical positions, and they are illustrated for the sake of descriptive convenience.

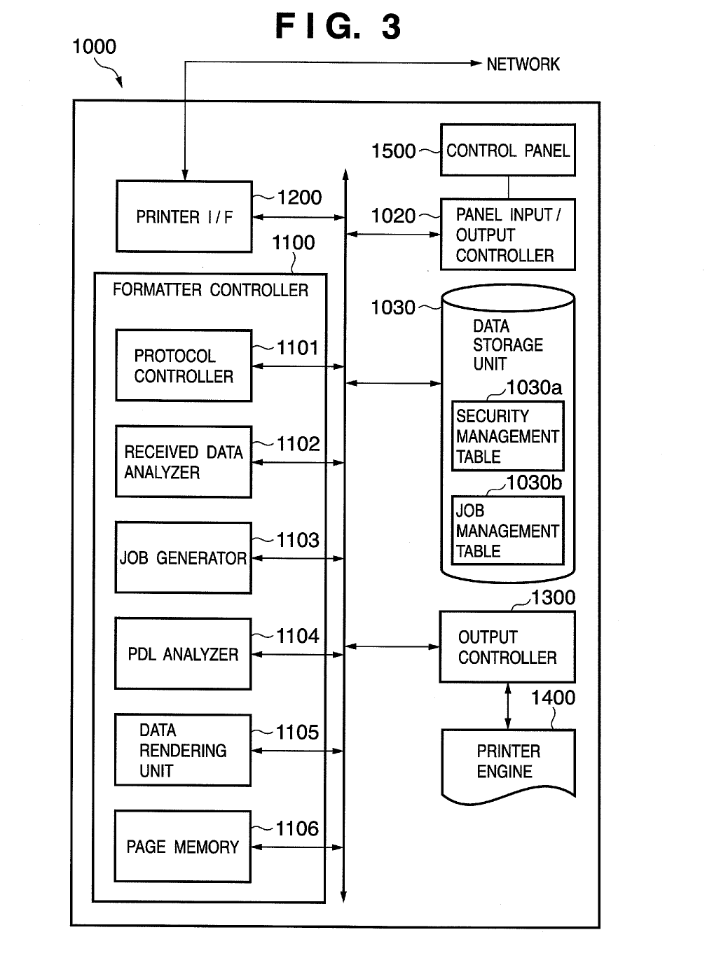

FIG. 3 is a block diagram showing the internal arrangement of principal part of the MFP according to the first embodiment of the present invention.

Referring to FIG. 3, the printing apparatus (MFP) roughly comprises a formatter controller 1100, panel input/output controller 1020, data storage unit 1030, printer interface (I/F) 1200, output controller 1300, and printer engine 1400.

Note that the controllers including the panel input/output controller 1020, formatter controller 1100, and output controller 1300 are implemented by the control unit 760 and MFP control unit 770 in FIG. 2. The printer engine 1400 is mainly implemented by the laser exposure unit 720, image forming unit 730, and fixing unit 740 in FIG. 2.

The printer I/F 1200 controls inputs and outputs with an external apparatus.

The formatter controller 1100 comprises a protocol controller 1101, received data analyzer 1102, JOB generator 1103, PDL analyzer 1104, data rendering unit 1105, and page memory 1106.

Note that the formatter controller 1100 normally comprises a computer system having a CPU, ROM, RAM, and the like.

In the formatter controller 1100, the protocol controller 1101 makes external communications by analyzing and transmitting a network protocol. The received data analyzer 1102 analyzes received data from the host computer 1001, and recognizes set print setting information and corresponding processing contents.

Note that the received data from the host computer 1001 is configured by data which are set for identical document data with print contents (processing contents) for respective pages that form document data in correspondence with the levels of users (user level) as distribution destinations of the document data.

If some pages of document data include confidential information, even identical document data often desirably have different print contents in correspondence with internal and external uses of an office, and also with administrator and employee uses even for the internal use.

Hence, in the first embodiment, a printer driver on the host computer 1001 implements a configuration for setting processing contents of document data to be output for respective pages that form the document data in accordance with the user levels.

The processing contents include, for example, a normal print mode for normally printing a page, a copy-forgery-inhibited-pattern print mode for printing an additional image for copy suppression such as a copy-forgery-inhibited-pattern-image or the like onto a page, a print inhibition mode for inhibiting printing of a page itself, and the like. In the arrangement of the first embodiment, print data used to execute various kinds of print processing are generated on the host computer 1001 in advance, and the MFP 1000 generates and outputs a JOB corresponding to received print data.

The JOB generator 1103 generates a JOB (print job) corresponding to received data to be processed. The JOB generator 1103 temporarily stores the generated JOB in the data storage unit 1030. The data storage unit 1030 comprises a job management table 1030b used to manage information (job information) associated with the stored job. The panel input/output controller 1020 can output an operation dialog such as a job status dialog or the like onto a control panel 1500 of the MFP 1000 with reference to this job management table 1030b.

The PDL analyzer 1104 analyzes PDL data based on the JOB stored in the data storage unit 1030 and converts that data into intermediate data in an easier-to-be-processed format. The intermediate data generated by the PDL analyzer 1104 is passed to and processed by the data rendering unit 1105. The data rendering unit 1105 rasterizes the intermediate data to bitmap data, and sequentially renders the rasterized bitmap data onto the page memory 1106.

The panel input/output controller 1020 controls inputs and outputs from the control panel 1500. The data storage unit 1030 stores received data and intermediate data for PDL print processing, and is implemented by, e.g., a secondary storage device such as a hard disk or the like. As described above, the data storage unit 1030 stores various data such as a security management table 1030a, the job management table 1030b, and the like, jobs to be printed, and printed jobs.

Note that the security management table 1030a will be described in the second embodiment.

The output controller 1300 converts the contents of the page memory 1106 into an image signal, and transfers the converted image signal to the printer engine 1400. The printer engine 1400 is a print mechanism that forms a permanent visible image on a print sheet based on the received image signal.

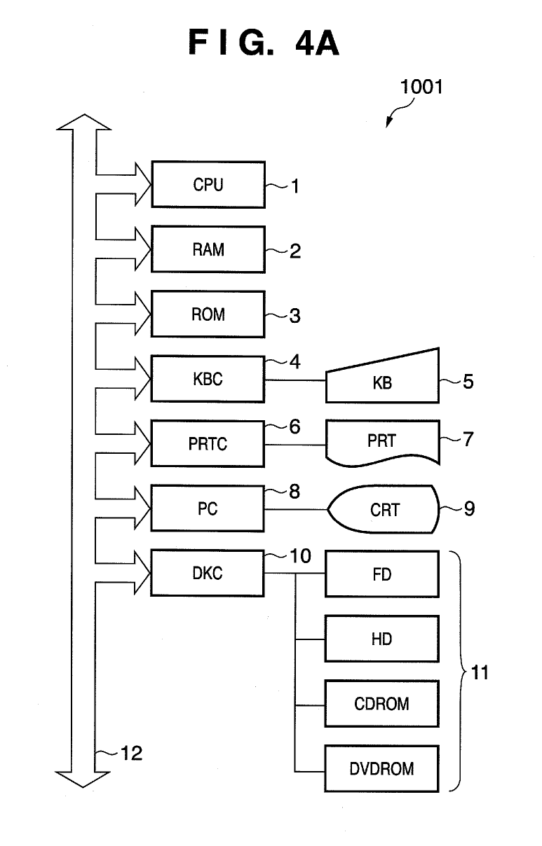

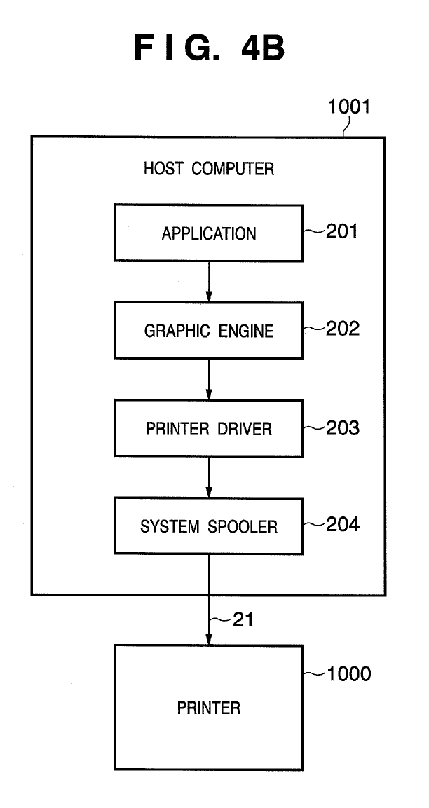

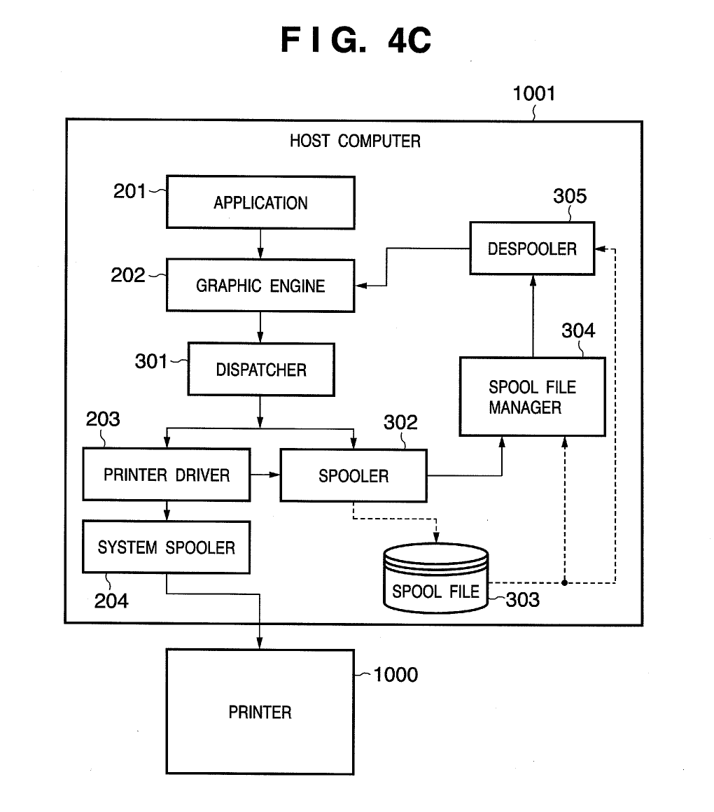

The arrangement of the host computer 1001 will be described below using FIG. 4A.

FIG. 4A is a block diagram showing the arrangement of the host computer suited to the information processing apparatus according to the first embodiment of the present invention.

Referring to FIG. 4A, reference numeral 1 denotes a CPU, i.e., a central processing unit, which controls the entire host computer 1001, and executes arithmetic processing. Reference numeral 2 denotes a RAM, i.e., a random access memory, which provides an area on which programs and data are loaded and executed for each processing. Reference numeral 3 denotes a ROM, i.e., a read-only memory, which provides a storage area of system control programs, font data, and the like.

Reference numeral 4 denotes a keyboard controller (KBC), which receives data based on key inputs from a KB (keyboard) 5 and transfers it to the CPU 1. Reference numeral 6 denotes a printer controller (PRTC) which controls a PRT (printer) 7. The PRT 7 comprises an MFP, laser beam printer, ink-jet printer, or the like.

Reference numeral 8 denotes a display controller (DC), which performs display control on a display (CRT) 9. Reference numeral 10 denotes a disc controller (DKC) which controls data transfer and the like.

Reference numeral 11 denotes an external storage device such as an FD (floppy® disk device), HD (hard disk device), CD (CD-ROM), DVD (DVD-ROM), or the like. This external storage device 11 stores various programs and data such as a printer driver and the like suited to the print control program of the present invention, and these programs and data are referred to or loaded onto the RAM 2 as needed upon execution. Reference numeral 12 denotes a system bus, which serves as a data transfer path among the aforementioned components.

Note that the external storage device 11 stores a printer driver which executes control associated with print processing to the MFP 1000, and displays a print setting dialog used to make various print settings for print data to be output to the MFP 1000.

The host computer 1001 operates when the CPU 1 executes a basic I/O (input/output) program and OS (operating system).

The basic I/O program is stored in the ROM 3, and the OS is written in the external storage device 11. When the power switch of the host computer 1001 is turned on, the OS is loaded from the external storage device 11 onto the RAM 2 by an IPL (initial program loading) function in the basic I/O program, thus starting the operation of the OS. Upon execution of print processing, the user can make various settings associated with the printer via the print setting dialog displayed by the printer driver.

The principal functional arrangement of the host computer 1001 will be described below using FIG. 4B.

FIG. 4B is a block diagram showing the principal functional arrangement of the host computer according to the first embodiment of the present invention.

Note that FIG. 4B shows a typical arrangement required to implement print processing in the host computer 1001 to which the MFP 1000 is connected directly or via the network.

An application 201, graphic engine 202, printer driver 203, and system spooler 204 exist as files saved in the external storage device 11. These files are program modules which are loaded onto the RAM 2 by the OS or modules which use these modules and are executed. The application 201 and printer driver 203 can be added to the external storage device 11 directly or via the network 1002.

The application 201 saved in the external storage device 11 is loaded onto the RAM 2 and is executed. However, when print processing is executed from the application 201 to the MFP 1000, the application 201 performs output (rendering) using the graphic engine 202 which is similarly loaded onto the RAM 2 and is ready to run.

The graphic engine 202 similarly loads onto the RAM 2 the printer driver 203, which is prepared for each type of a printer to be connected from the external storage device 11. The graphic engine 202 then converts the output (print data) from the application 201 into a print control command using the printer driver 203. The converted print control command goes through the system spooler 204 which is loaded onto the RAM 2 by the OS, and is output to the MFP 1000 via an interface 21.

Note that the present invention is premised on the printing system which comprises the MFP 1000 and host computer 1001, as shown in FIG. 4B. However, the printing system can be further enhanced to a system which temporarily spools print data from the application 201 as intermediate code data (print data in an intermediate code format), as shown in FIG. 4C.

FIG. 4C shows the principal functional arrangement obtained by enhancing that in FIG. 4B, and adopts the arrangement for temporarily generating a spool file 303 including intermediate code data upon transmitting a print command from the graphic engine 202 to the printer driver 203.

In FIG. 4B, the application 201 is released from the print processing after the printer driver 203 has converted all print instructions from the graphic engine 202 into a print control command. By contrast, in FIG. 4C, the application 201 is released from the print processing when a spooler 302 has converted all print instructions to intermediate code data and has output the converted data to the spool file 303. Normally, the latter processing requires a shorter period of time.

In FIG. 4C, the contents of the spool file 303 can be modified. In this manner, print data from the application 201 can undergo modification processing such as a change in page print order, enlargement/reduction, rotation, printing of a plurality of pages on one sheet in a reduced scale, and the like. Also, the functions (modification processing) other than those of the application can be implemented. In order to implement such modification processing, the arrangement for temporarily spooling print data as intermediate code data shown in FIG. 4C is adopted in place of that shown in FIG. 4B.

In order to execute the modification processing of print data, the user normally makes settings from a window (printer driver dialog) provided by the printer driver 203, which saves the setting contents on the RAM 2 or external storage device 11.

In the arrangement shown in FIG. 4C, a dispatcher 301 receives print instructions from the graphic engine 202. The dispatcher 301 checks if the print instructions received from the graphic engine 202 are those issued from the application 201 to the graphic engine 202. If the print instructions are issued from the application 201 to the graphic engine 202, the dispatcher 301 loads the spooler 302 stored in the external storage device 11 onto the RAM 2. Then, the dispatcher 301 sends the print instructions to the spooler 302 in place of the printer driver 203.

The spooler 302 interprets the received print instructions, converts them into, e.g., intermediate code data for respective pages, and outputs the converted data to the spool file 303. The spooler 302 acquires print setting information for print data set in the printer driver 203 from the printer driver 203. The spooler 302 saves the acquired print setting information in the spool file 303 as a setting file for each job.

Note that the spool file 303 is generated as a file on the external storage device 11 but it may be generated on the RAM 2. Furthermore, the spooler 302 loads a spool file manager 304 stored in the external storage device 11 onto the RAM 2, and notifies the spool file manager 304 of the generation status of the spool file 303. After that, the spool file manager 304 checks if print processing can be done according to the contents of the print setting information associated with the print data in the intermediate code format saved in the spool file 303.

If the spool file manager 304 determines that the print processing can be done using the graphic engine 202, it loads a despooler 305 stored in the external storage device 11 onto the RAM 2. The spool file manager 304 instructs the despooler 305 to execute print processing of a page rendering file of intermediate code data described in the spool file 303.

The despooler 305 modifies the page rendering file of intermediate code data included in the spool file 303 in accordance with the print setting information included in the spool file 303, regenerates print instructions, and outputs them via the graphic engine 202 again.

The dispatcher 301 checks if the print instructions received from the graphic engine 202 are those issued from the despooler 305 to the graphic engine 202. If the print instructions are issued from the despooler 305 to the graphic engine 202, the dispatcher 301 sends the print instructions to the printer driver 203 in place of the spooler 302.

The printer driver 203 generates a print control command based on the print instructions from the graphic engine 202, and outputs it to the MFP 1000 via the system spooler 204.

Note that FIG. 4C explains the printer driver 203 as a functional component used to generate print data in a PDL format for the sake of simplicity, and illustrates it independently of other functional components. However, the dispatcher 301, spooler 302, spool file manager 304, and despooler 305 are installed in the host computer as a series of printer driver components together with the printer driver 203. For this reason, the printer driver normally indicates a series of printer driver components, and the print control program of the present invention corresponds to the series of printer driver components.

The print setting dialog generated by a UI driver module component included in the printer driver 203 will be described below.

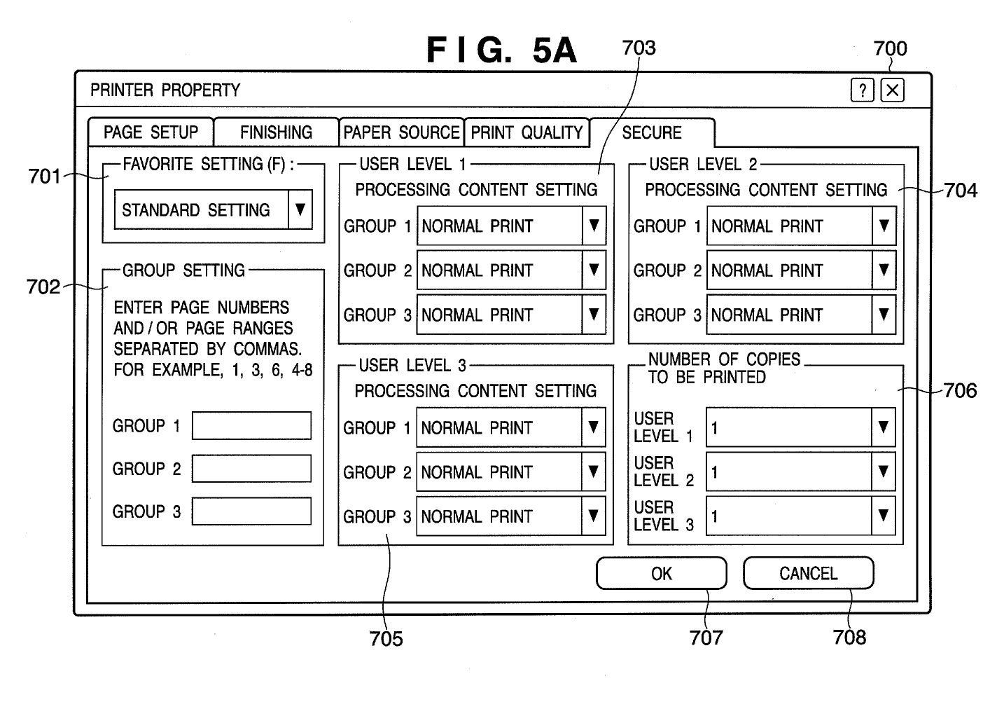

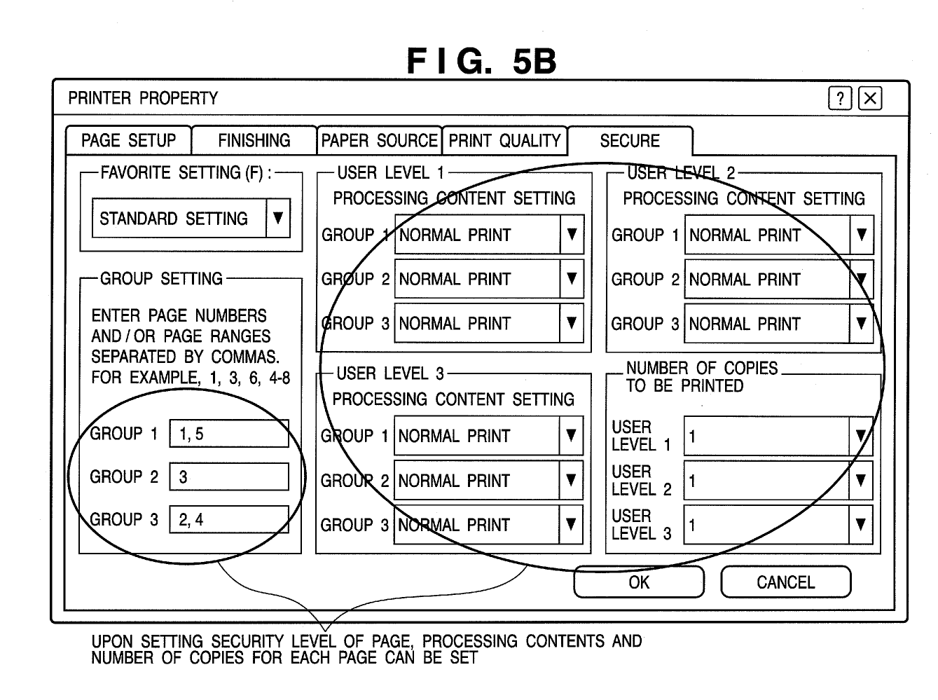

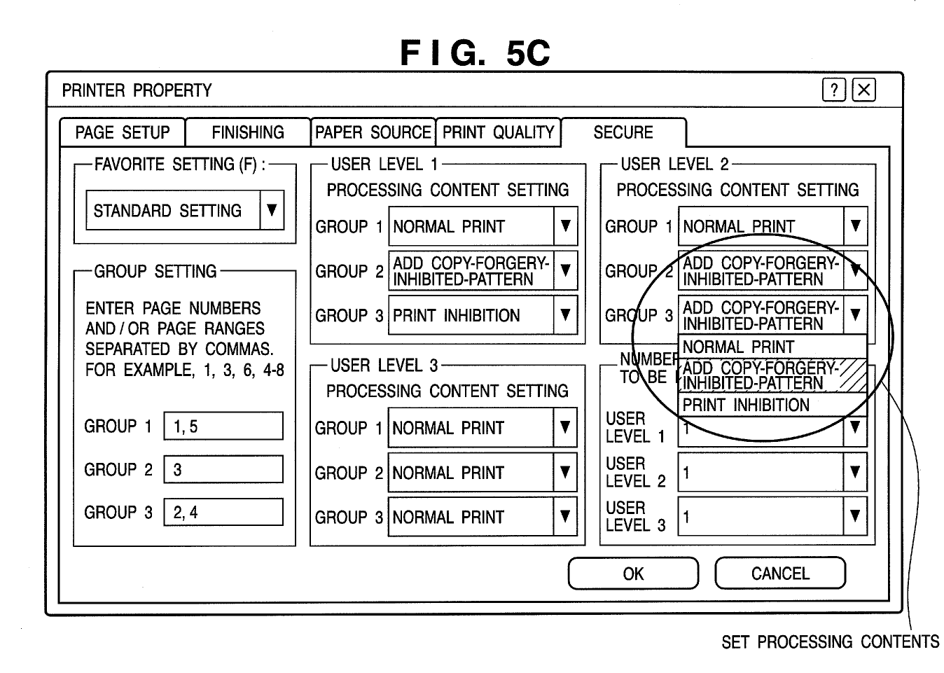

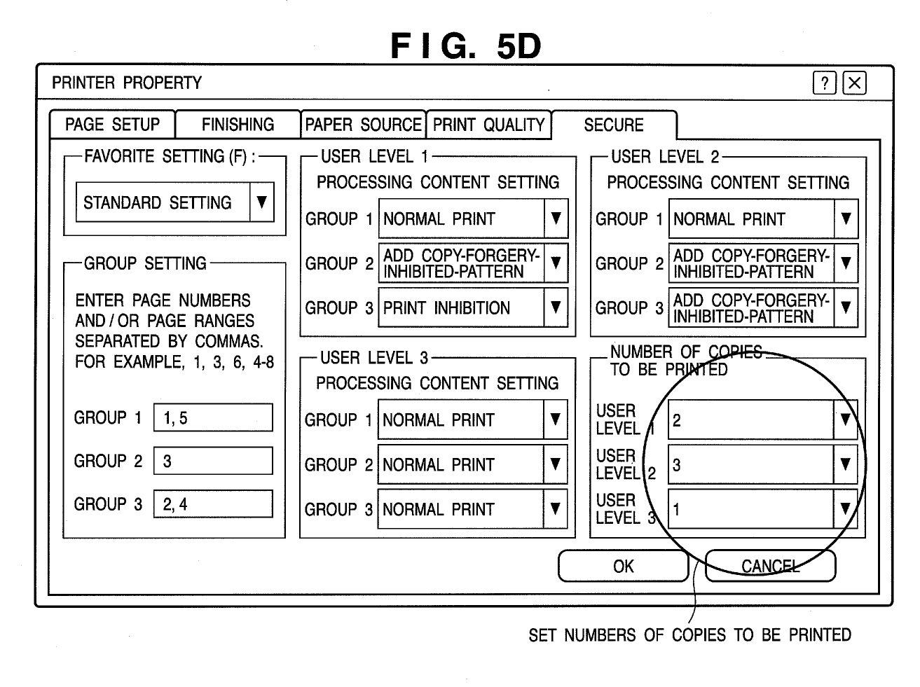

FIG. 5A shows an example of the print setting dialog according to the first embodiment of the present invention.

A print setting dialog 700 is generated by the UI driver module component of the printer driver 203 in the host computer 1001, and is generally called a print property dialog. When the user wants to print a document from an arbitrary application, he or she makes print settings via this print setting dialog 700, and the printer driver 203 generates print data using the set print settings.

The print setting dialog 700 includes tab setting windows which can set various print settings for respective categories, as shown in, e.g., FIG. 5A. In this example, a plurality of tab setting windows include those with setting items “page setup”, “finishing”, “paper source”, “print quality”, and “secure”.

The “page setup”, “finishing”, “paper source”, and “print quality” tab setting windows have setting item (basic setting item) groups associated with normal print processing, and the user can set various sprint settings on the respective tab setting windows.

On the other hand, on the “secure” tab setting window as a characteristic feature of the present invention, the user can set groups and the like used to set processing contents for respective pages that form document data. Furthermore, on this “secure” tab setting window, various controls as setting items used to make this setting are formed.

Note that document data includes text information, image information, and the like created by a document creation application installed in the host computer 1001, and has page data of logical page information. Note that a logical page means a page unit divided by the application.

On the “secure” tab setting window, reference numeral 701 denotes a favorite setting field. This field includes a pull-down menu, which is registered with a plurality of types of sets (favorites) of setting items designated in advance. When the user selects this set of setting items, he or she can reflect setting item values set by that set to respective setting items of the tab setting window. Also, the user can register a set of newly designated setting items as a favorite.

Reference numeral 702 denotes a group setting input field. This field includes text input fields, and allows to individually set groups for respective pages which form document data to be processed. In this case, as groups, the input fields for three different groups (groups 1 to 3) are prepared. The user designates desired page numbers or a page range in a desired input field, thus designating a group of pages.

Note that the page number or page range input in this group setting input field 702 means the number of a logical page or the range of logical pages.

Reference numerals 703 to 706 denote fields used to set the processing contents and the number of copies to be printed for pages that belong to each group for each user level. When the group of pages is set in the group setting input field 702, each of these fields allows to set the processing contents and the number of copies to be printed for that group in correspondence with each user level.

Note that the first embodiment uses an expression “user level” since it is easy to describe users who have high, middle, and low security levels as the use purpose. However, since the object of the present invention is to change the contents of printouts in correspondence with the types of users, the user levels suffice to be used to specify the types of users.

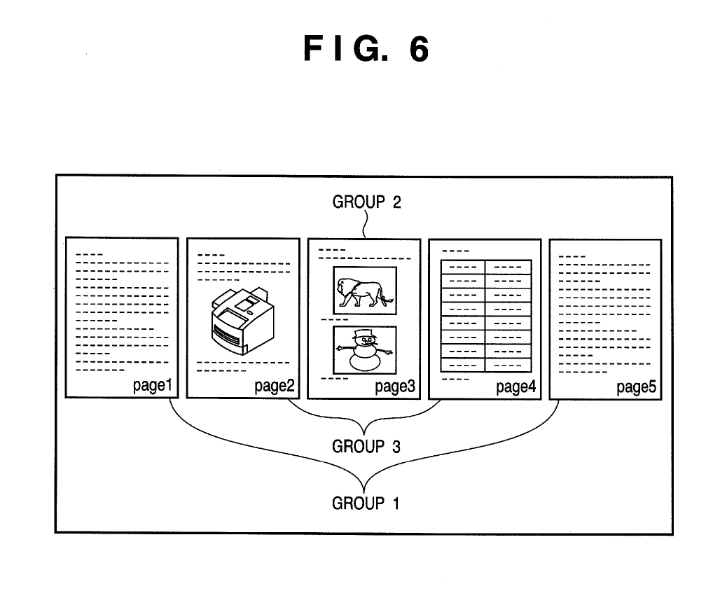

An example of FIG. 5B shows a display state after groups are set for respective pages that form document data shown in FIG. 6.

That is, in FIG. 5B, the first and fifth pages of document data (FIG. 6) including five pages are set as group 1. The second and fourth pages are set as group 3. The third page is set as group 2.

The description will revert to FIG. 5A.

Referring to FIG. 5A, reference numerals 703 to 705 denote processing content setting fields used to designate the processing contents of pages which belong to each group in correspondence with each level of the user (user level) as a distribution destination of printouts output by the MFP 1000. Each of these fields includes pull-down menus. With this configuration, the user can designate the processing contents for a group assigned to pages that form the document data using the processing content setting field for each user level.

For example, the processing content setting field 703 includes pull-down menus used to set processing contents for pages which respectively belong to groups 1 to 3 upon distributing printouts to users of user level 1. Each pull-down menu is registered with a plurality of types of print methods as the processing contents, and the user can designate a desired one of these print methods. The types of print methods include a normal print mode, copy-forgery-inhibited-pattern print mode, print inhibition mode, and the like.

The processing content setting fields 704 and 705 are used for distribution destinations of user levels 2 and 3, and allow the same settings as in the processing content setting field 703.

An example shown in FIG. 5C shows a display state after the settings on the processing content setting field are complete for respective pages which form the document data shown in FIG. 6, and settings on the processing content setting field 704 are in progress.

The description will revert to FIG. 5A.

Referring to FIG. 5A, reference numeral 706 denotes a print copy count setting field used to designate the number of copies to be printed of document data according to the user levels. This field includes pull-down menus. With this configuration, the user can designate the number of copies to be printed of document data which is printed to have the processing contents according to each user level. The numbers of copies to be printed are registered in advance in each pull-down menu, and the user can designate a desired one of the numbers of copies to be printed. The user can directly input a desired numerical value to the print copy count setting field 706.

An example shown in FIG. 5D shows a display state after the numbers of copies to be printed of document data which is printed using the processing contents according to the user levels are set for respective groups to which pages that form the document data shown in FIG. 6 belong.

Various settings set on the print setting dialog 700 are stored as print setting information in, e.g., the RAM 2 of the host computer 1001 upon pressing an OK button 707.

The printer driver 203 generates print data by applying the print settings specified by this print setting information to document data to be printed, and outputs that print data to the MFP 1000 as a print job. On the other hand, upon pressing a cancel button 708, the setting contents set on the print setting dialog 700 are canceled.

The print job generated in this case may be transmitted as a secure print job. When the print job is transmitted as a secure print job, the MFP 1000 does not start print processing until the user inputs a print instruction from the control panel 1500. At this time, based on the level (which is set in advance) of an operator who inputs the print instruction from the control panel 1500, the print job can be printed out according to the processing contents which are set for a user level matching that set in the designated secure print job.

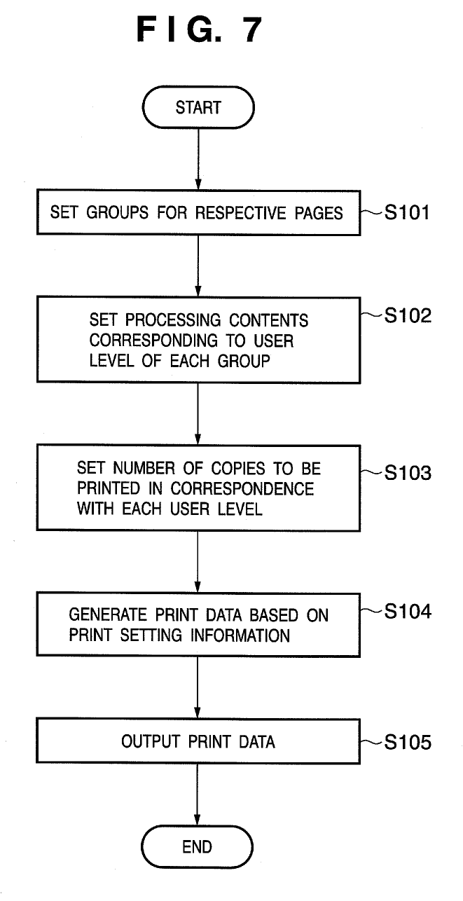

The print setting processing executed by the host computer 1001 of the first embodiment will be described below using FIG. 7.

FIG. 7 is a flowchart showing the print setting processing executed by the printer driver 203 which runs on the host computer according to the first embodiment of the present invention.

For example, upon printing document data shown in FIG. 6, the printer driver 203 displays the print setting dialog 700 (FIG. 5A), and makes settings of pages corresponding to respective groups based on the operations on the print setting dialog (FIG. 5B) in step S101.

In step S102, the printer driver 203 sets the processing contents corresponding to the user levels for respective groups based on the operations on the print setting dialog (FIG. 5C).

In step S103, the printer driver 203 sets the numbers of copies to be printed in correspondence with the user levels based on the operations on the print setting dialog (FIG. 5D). With the above settings in steps S101 to S103, the printer driver 203 generates print setting information.

In step S104, the printer driver 203 receives rendering data to be printed from the application 201 via the graphic engine 202, and generates print data which can be interpreted by the printer based on the print setting information generated in steps S101 to S103.

Note that this print data is generated according to the processing described using FIG. 4B or 4C above. In step S105, the printer driver 203 outputs the generated print data to the printer (e.g., MFP 1000).

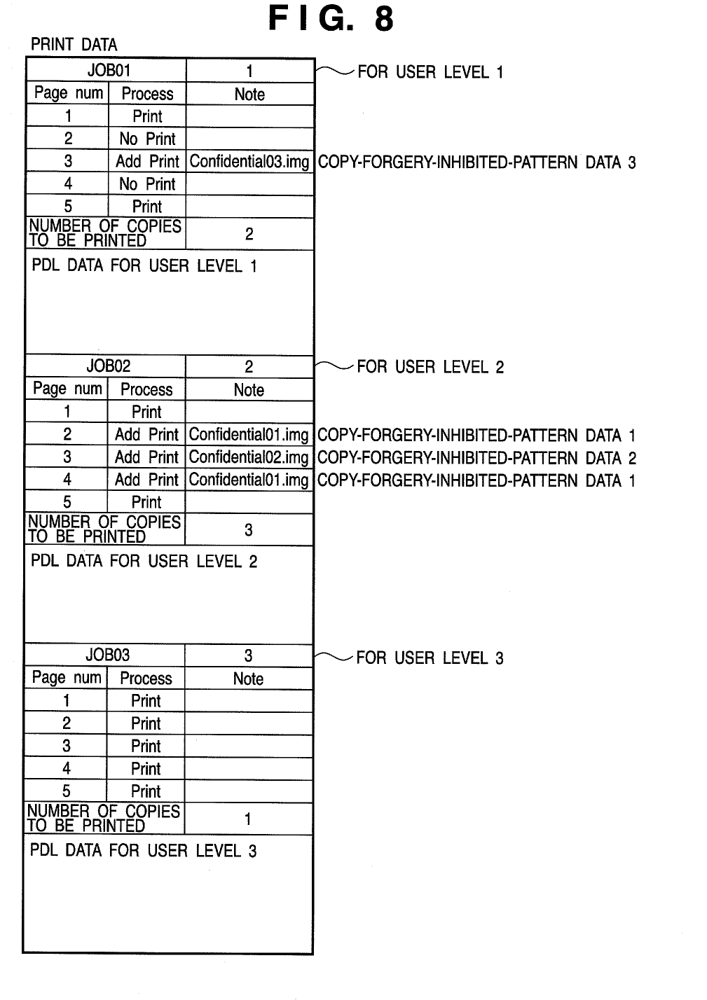

An example of print data at that time will be described below using FIG. 8.

FIG. 8 shows an example of a print job including print data according to the first embodiment of the present invention.

The first embodiment generates setting information for respective user levels and PDL data according to the setting information based on print setting information as print data. Note that the PDL data is the same as that to be transferred to a conventional printer such as a MFP, laser beam printer, ink-jet printer, and the like.

The print data shown in FIG. 8 is generated for the document data shown in FIG. 6, and the print setting information is set to include the processing contents of pages at user levels 1 to 3, respectively.

At user level 1, the first and fifth pages have a normal print setting, the second and fourth pages have a print inhibition setting, and the third page has a copy-forgery-inhibited-pattern print setting. As an image to be added as a copy-forgery-inhibited-pattern in the copy-forgery-inhibited-pattern print processing of the third page, an image with a file name “Confidential03.jpg” is set.

At user level 2, the first and fifth pages have a normal print setting, and the second to fourth pages have a copy-forgery-inhibited-pattern print setting. As images to be added as copy-forgery-inhibited-patterns in the copy-forgery-inhibited-pattern print processing of the second to fourth pages, images with file names “Confidential01.jpg” to “Confidential03.jpg” are respectively set.

Note that images to be added need not be different, and identical images may be added.

At user level 3, all the first to fifth pages have a normal print setting.

In this way, the print job of the first embodiment includes a print setting part that describes the processing content and a print data part of PDL data for each user level, and is repeated in correspondence with user levels as print targets. The print job generated in this case may be a normal print job which sequentially undergoes print processing by the MFP 1000 which receives the job in accordance with a print order, or may be a secure print job, as described above.

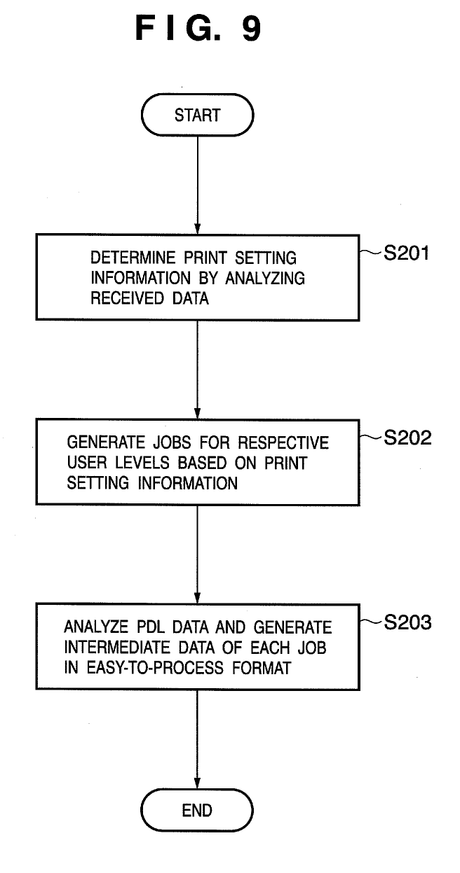

The print processing executed by the MFP 1000 based on received data from the host computer 1001 will be described below using FIG. 9.

FIG. 9 is a flowchart showing the print processing executed by the MFP according to the first embodiment of the present invention.

Note that FIG. 9 will explain processing until print intermediate data is generated based on print data in a print job received from the host computer 1001.

In step S201, the received data analyzer 1102 analyzes received data to determine a plurality of pieces of print setting information of the PDL data corresponding to different user levels, which form the received data.

In step S202, the JOB generator 1103 generates a JOB required to print the PDL data corresponding to each user level based on the determined print setting information. In this case, since there are three types of PDL data corresponding to the user levels, three different JOBs are generated.

In step S203, the PDL analyzer 1104 analyzes the generated PDL data and generates intermediate data in an easier-to-be-processed format. This intermediate data is temporarily stored in the data storage unit 1030, and is then printed.

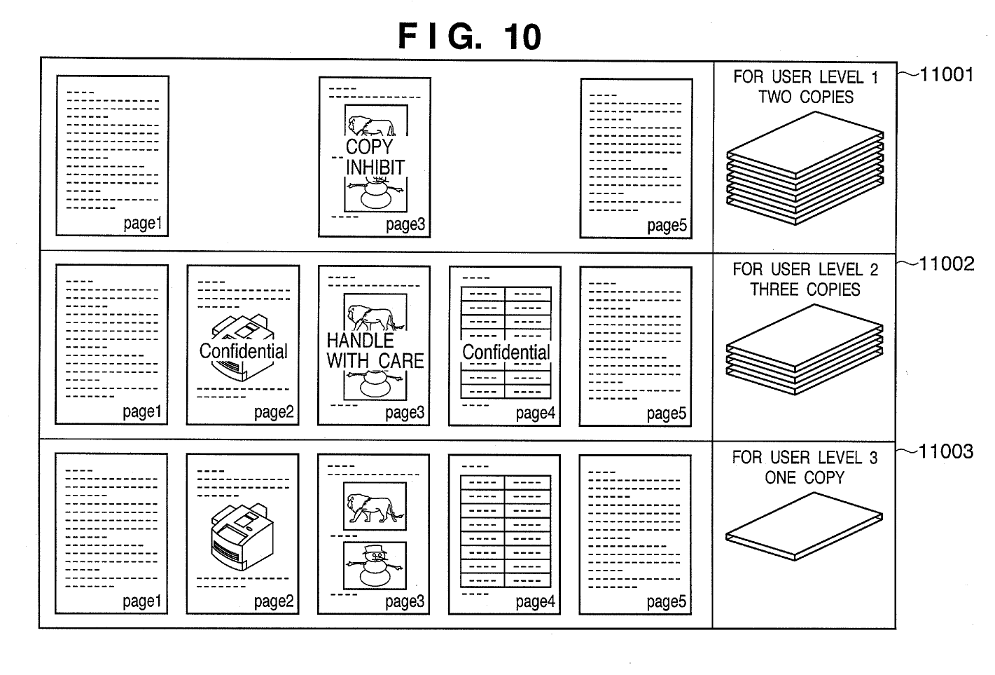

FIG. 10 shows an output result example obtained by the processing in FIG. 9 when the document data shown in FIG. 6 is input to the MFP 1000.

In the print settings of user level 1, the processing contents of the first and fifth pages in the document data indicate the normal print mode. Also, the processing contents of the second and fourth pages indicate the print inhibition mode. Furthermore, the processing contents of the third page indicate the copy-forgery-inhibited-pattern print mode. The number of copies to be printed of the entire document data according to these processing contents is 2.

Therefore, as shown in a print example 11001 in FIG. 10, print processing at user level 1 obtains the normal print results of the first and fifth pages in the document data, and the copy-forgery-inhibited-pattern print result of the third page. Also, since the second and fourth pages have the print inhibition setting, they are not printed. The number of copies to be printed of the entire document data according to these processing contents is 2.

In the print settings of user level 2, the processing contents of the first and fifth pages in the document data indicate the normal print mode. Also, the processing contents of the second to fourth pages indicate the copy-forgery-inhibited-pattern print mode. As images to be added as copy-forgery-inhibited-patterns, a common image is added to the second and fourth pages, and another image is added to the third page. The number of copies to be printed of the entire document data according to these processing contents is 3.

Therefore, as shown in a print example 11002 in FIG. 10, print processing at user level 2 obtains the normal print results of the first and fifth pages in the document data, and the copy-forgery-inhibited-pattern print results of the second to fourth pages, and the number of copies to be printed of the entire document data according to these processing contents is 3.

In the print settings of user level 3, the processing contents of all the groups set for respective pages in the document indicate the normal print mode. The number of copies to be printed of the entire document data according to these processing contents is 1.

Therefore, as shown in a print example 11003 in FIG. 10, print processing at user level 3 prints all pages in the document data, and the number of copies to be printed is 1.

As described above, using the print setting dialog in FIG. 5A, the user can set print contents according to the user levels in one document data. Thus, the host computer 1001 can control the MFP 1000 to output printouts of the print contents according to the user levels by only one print instruction of the document data.

For example, in the examples of FIG. 10, when the document data in FIG. 6 and print setting information for that document data are input to the MFP 1000, two copies of printouts for user level 1, three copies of printouts for user level 2, and one copy of printouts for user level 1 can be obtained at the same time.

As described above, according to the first embodiment, groups are set for respective pages of document data to be printed, and the processing contents corresponding to the user types (user levels) as distribution destinations of the document data can be set for each group. In this way, print processes with print contents corresponding to a plurality of user levels can be executed by a single print operation, thus improving the user's convenience.

### Second Embodiment

The first embodiment has explained the arrangement in which by making print settings of print contents in identical document data corresponding to different user levels on the host computer 1001 side, printouts with print contents according to the respective user levels can be printed based on the identical document data at the same time.

By contrast, the second embodiment adopts print settings according to the security level of a user who operates the MFP 1000 when the MFP 1000 receives print data with the print settings described in the first embodiment. An arrangement that allows to print only printouts with print contents suited to the security level will be explained.

In case of the arrangement of the second embodiment, the MFP 1000 has an authentication function of authenticating a user who operates the MFP 1000. With this authentication function, the security level of the user is determined. That is, in the MFP 1000, user security levels for limiting the print processing such as the operation, print processing, and the like of the MFP 1000 are set for respective users who operate the MFP 1000.

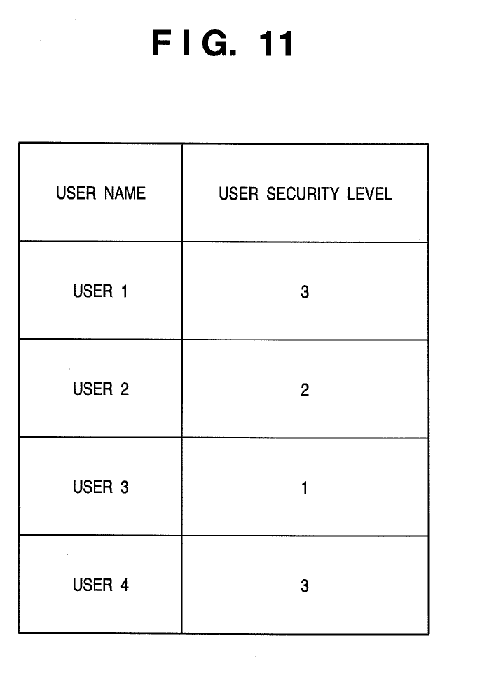

For example, the received data analyzer 1102 in FIG. 3 determines this user security level. Especially, the received data analyzer 1102 determines the user security level with reference to the security management table 1030a shown in FIG. 11.

The security management table 1030a manages security levels for respective users who operate the MFP 1000, as shown in FIG. 11. For example, the administrator who operates the MFP 1000 can set a security level for each user. Security levels 1 to 3 respectively correspond to user levels 1 to 3 of the first embodiment. For this reason, by determining the security level of the user, print setting information of the corresponding user level can be determined from print data having print setting information of the plurality of types of user levels.

That is, the received data analyzer 1102 can determine the user security level for the user (login user) who operates the MFP 1000 with reference to the security management table 1030a. The received data analyzer 1102 can recognize the processing contents of respective pages which form the print data to be processed based on the print setting information of the user level corresponding to the determined security level.

The processing contents include, for example, a normal print mode for normally printing a page, a copy-forgery-inhibited-pattern print mode for printing an additional image for copy suppression such as a copy-forgery-inhibited-pattern-image or the like onto a page, a print inhibition mode for inhibiting printing of a page itself, and the like, as described above. The MFP 1000 can individually execute the processing contents for each page based on the user level set in the print setting information of the print data.

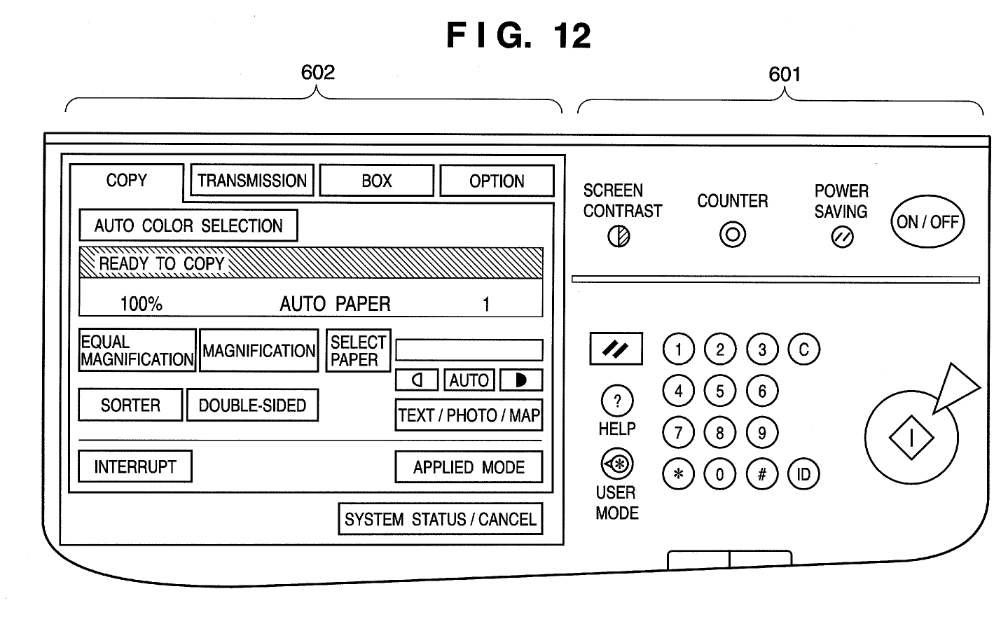

Prior to a description of processing of a job on the printer side, an example of the control panel 1500 of the MFP 1000 will be described below using FIG. 12.

FIG. 12 shows an example of the control panel according to the second embodiment of the present invention.

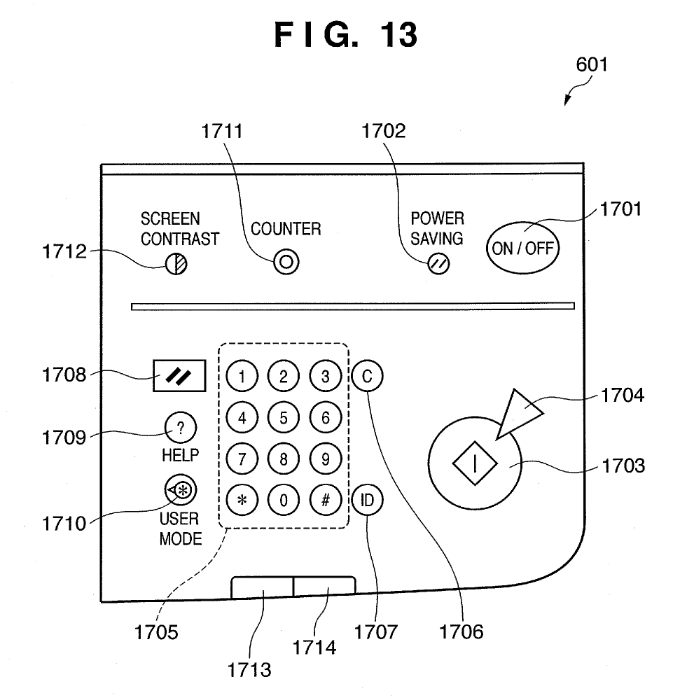

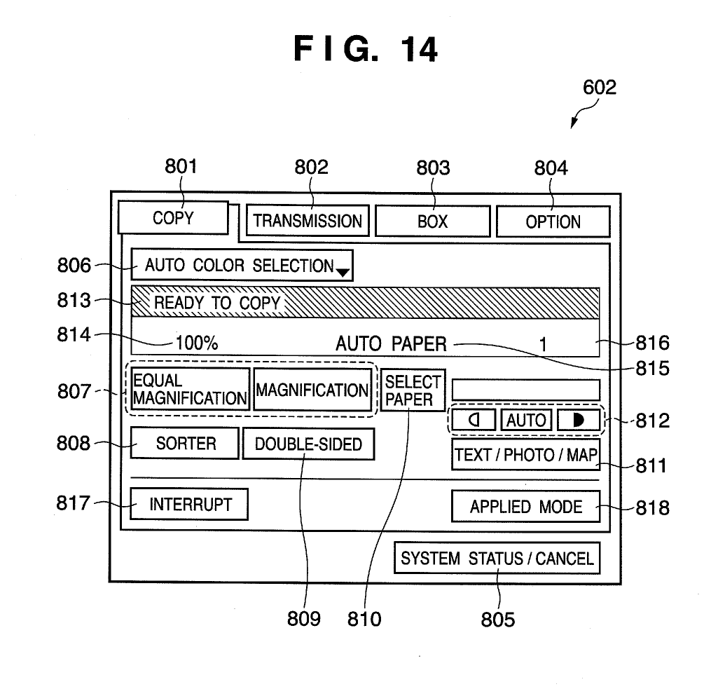

The control panel 1500 of the MFP 1000 comprises a key input unit 601 and touch panel unit 602. FIGS. 13 and 14 show details of these key input unit 601 and touch panel unit 602, which will be described below.

The key input unit 601 shown in FIG. 13 is a key input part that allows ordinary operation settings.

A control panel power switch 1701 is used to switch a standby mode (normal operation state) and a sleep mode (a state in which a main controller stops programs in an interrupt wait state to prepare for network print processing, facsimile processing, or the like, so as to save consumption power) This control panel power switch 1701 allows control while a main power switch which supplies electric power of the entire system is ON.

A power saving switch 1702 can suppress power consumption by decreasing the control temperature of the fixing unit 740 (FIG. 1) in the standby mode although it takes time until a printable state. The control temperature can be lowered by setting a power saving ratio.

A start key 1703 is used to instruct start of various kinds of processing such as copying, transmission, and the like. A stop key 1704 is used to interrupt the start of various kinds of processing.

A numeric keypad 1705 is used to set numerical values of various settings. A clear key 1706 is used to clear the set value. An ID key 1707 is used to make an operator (user) input a pre-set personal identification number (identification information) to authenticate that operator of the MFP 1000.

A reset key 1708 is used to reset various settings to a default state. A help key 1709 is used to display a guidance and help. A user mode key 1710 is used to shift to a system setting window for each user.

A counter confirmation key 1711 is used to display the number of output sheets stored in a software counter which counts the number of printed sheet and the like provided in the MFP 1000. In this case, the numbers of output sheets can be displayed in correspondence with an operation mode such as a copy mode, print mode, scan mode, FAX mode, and the like, a color mode such as a color mode, monochrome mode, and the like, a paper size such as a large size, small size, and the like, and so forth.

An image contrast dial 1712 is used to adjust the viewability of the screen by controlling a backlight of a liquid crystal display of the touch panel unit 602.

An execution/memory lamp 1713 flickers during execution of a job or access to a memory to notify the user of that fact. An error lamp 1714 flickers in case of errors such as an execution error of a job, service person call, and the like, an operator call that informs paper jam, out of expendable, or the like to notify the user of that fact.

The touch panel unit 602 comprises an LCD (Liquid Crystal Display) and a touch panel display, which comprises transparent electrodes and is adhered on that LCD. When the user touches a transparent electrode of a portion corresponding to a given key displayed on the LCD, processing for displaying another operation dialog by detecting that touch is programmed in advance. FIG. 14 shows an initial dialog in the standby mode, and various operation dialogs can be displayed according to setting operations.

A copy tab 801 is a tab key to be pressed upon transition to an operation dialog of a copy operation. A transmission tab 802 is a tab key to be pressed upon transition to an operation dialog used to instruct a transmission operation such as FAX transmission, E-mail transmission, or the like. A box tab 803 is a tab key to be pressed upon transition to an operation dialog used to input/output a job to a box (storage means which is used to store a job, and is assured on, e.g., the data storage unit 1030). An option tab 804 is a tab key to be pressed upon transition to a setting dialog used to set option functions of scanner settings, printer settings, and the like, and to a job status dialog. By selecting one of these tabs, the control can transit to the corresponding operation mode.

A system monitor key 805 is used to display the condition and status of the MFP 1000. A color selection setting key 806 is used to select a color copy mode, monochrome copy mode, or automatic selection mode in advance. A magnification setting key 807 is pressed upon transition to a magnification setting dialog used to set an enlargement magnification, reduction magnification, or the like. A post-processing setting key 808 is used to set the presence/absence, number, positions, and the like of stapling, punching, and the like, and to transit to an operation dialog such as job status display or the like.

A double-sided setting key 809 is to be pressed upon transition to a double-sided setting dialog used to select single-sided printing or double-sided printing. A paper size setting key 810 is to be pressed upon transition to a paper size setting dialog used to select a paper source, paper size, and media type. An image mode setting key 811 is used to select an image mode such as a text mode, photo mode, or the like suited to read a document image. A density setting key 812 is used to adjust the density of an output image to be higher or lower.

A status display unit 813 performs simple status display such as a standby state, warming up, jam, error, and the like. A magnification display unit 814 displays the magnification set by the magnification setting key 807. A paper size display unit 815 displays the paper size and media type set by the paper size setting key 810. A print count display unit 816 displays the number of pages designated by the numeric keypad 1705 and displays a count value of the currently printed page during operation.

Furthermore, an interrupt key 817 is used to interrupt the current copy operation to start another job. An applied mode key 818 is to be pressed upon transition to a setting dialog used to set various kinds of image processing, layouts, and the like such as a page continuous copy mode, cover/inserting paper setting mode, reduced layout mode, image shift mode, and the like.

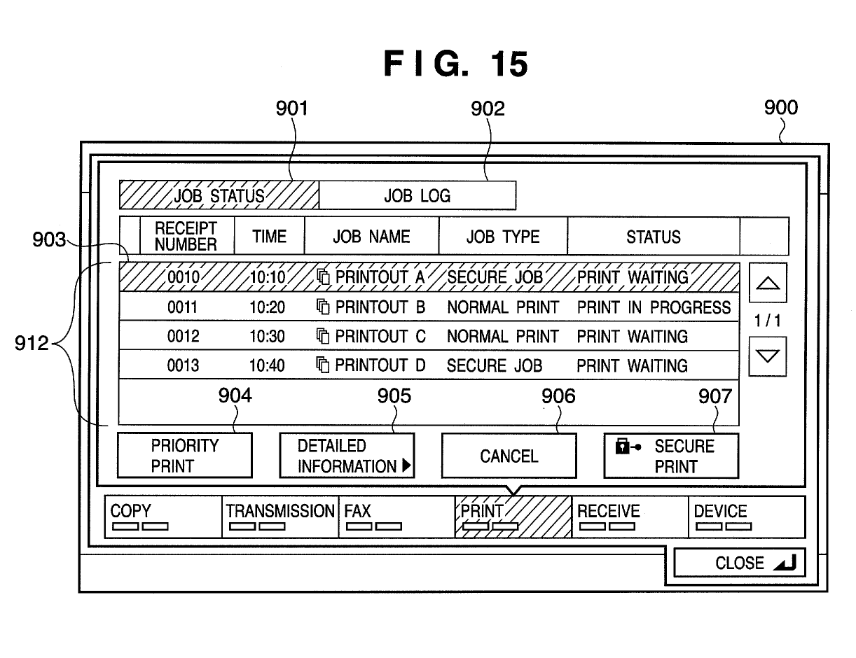

A job status dialog of a job whose printing is underway or jobs which wait for printing will be described below using FIG. 15.

FIG. 15 shows an example of the job status dialog according to the second embodiment of the present invention.

For example, when the user selects the option tab 804 on the touch panel unit 602 in FIG. 14, a job status dialog 900 (FIG. 15) having a print tab used to set the print operation by the printer is displayed. This job status dialog 900 displays printed, print-in-progress, or print-waiting jobs stored in the data storage unit 1030 with reference to the job management table 1030b. A job list 912 displays job information associated with each job such as a job name, job type, status, and the like.

The job status dialog 900 includes a job status button 901 and job log button 902. Upon pressing of the job status button 901, the job list 912 displays job information of print-in-progress or print-waiting jobs. Upon pressing of the job log button 902, the job list 912 displays a processing status (log) list of old jobs which were processed by the MFP 1000.

In this way, the job status dialog 900 allows two different status display modes (job status display and job log display) upon pressing of the job status button 901 or job log button 902.

These two different status display modes will be described in more detail below.

The job status display mode is used to confirm the status of each job whose processing is in progress, and the status of each job always changes. For this reason, the job management table 1030b constantly updates the status of each received job, and always saves the latest status.

List rows including a list row 903 that forms the job list has display items of a receipt number, time, job name, job type (normal job, secure job, etc.), and status (print in progress/error/print waiting/print end).

On this job status dialog 900, the user selects a desired one of the list rows displayed on the job list 912 and presses a detailed information button 905, thus displaying a detailed dialog (not shown) which shows the detailed status of a job corresponding to that list row. The detailed dialog displays, for example, the start time, the end time, status, the job type, the number of printed pages, the location of the MFP which executes processing, the IP address set for that MFP, and the like.

The job log display mode displays jobs, the print processing of which ended for some reason together. In this way, the operator can confirm the final states and processing results (OK/NG) of the previously processed jobs.

Note that both the job status display and job log display modes support unexpected power OFF (e.g., instantaneous power OFF), and the information of the job management table 1030b is saved after the power supply resumes.

Next, the job control of the processing contents and the like of a desired job selected from the job list 912 on the job status dialog 900 will be described below.

The job status dialog 900 allows to execute a priority print function (priority print button 904), job cancel function (cancel button 906), and secure print function (secure print button 907) as job control.

Note that the priority print function changes the print order of a job selected from a plurality of jobs input to the data storage unit 1030 so that the job is to be printed next to the job whose printing is now in progress. Normally, when jobs are input, print processing is done in the order they are input. However, upon printing a job with a high priority level, its order can be changed using this priority print function.

Upon pressing the priority print button 904, the priority order of the job corresponding to the selected list row is advanced. After the priority order is advanced, the job status display reflects that result.

The job cancel function cancels printing of a job corresponding to the selected list row. Upon pressing the cancel button 906, all processes of job data processed by the MFP 1000 are canceled. Also, the list row of the corresponding job is deleted from those on the job status display.

The secure print function (authentication print function) is used to print a highly confidential job (secure job) such as a confidential document or the like. A job to which this secure print function is applied is that of print data for which the user sets the user level via the print setting dialog (FIG. 5A) provided by the printer driver of the external apparatus. When the job (secure job) set with the user level is input to the MFP 1000, it is saved in the data storage unit 1030 in a job waiting state. The output operation of this job does not start until the operator inputs an instruction. Likewise, a secure job can be input on the MFP 1000.

When the operator executes print processing of the secure job, he or she comes to the MFP 1000 used to output the secure job, selects the list row of the secure job on the job status dialog 900, and selects the secure print button 907. With this selection, an input dialog (not shown) that prompts the operator to input a personal identification number is displayed. By inputting the personal identification number to this input dialog, the operator can print the secure job only when that personal identification number is correct.

On the other hand, if the operator inputs a wrong personal identification number value, no print start instruction is issued. Since secure jobs which are unnecessary or are not printed for a long period of time waste the memory resources of the MFP 1000, the operator can delete such secure jobs from the list on the job status dialog 900.

Also, by setting time limits of secure jobs, the formatter controller 1100 can automatically delete a secure job, for which a predetermined management period in the data storage unit 1030 has elapsed.

The print processing to be executed by the MFP 1000 based on received data from the host computer 1001 will be described below.

The print processing of the second embodiment basically executes the same processing as in FIG. 9 of the first embodiment, except that the second embodiment generates only a printout with print setting contents at the user level corresponding to the user security level unlike in the first embodiment.

The print processing of the second embodiment will be described with reference to the processing in FIG. 9. In step S201, the received data analyzer 1102 analyzes received data to determine a plurality of pieces of print setting information of the PDL data corresponding to different user levels, which form the received data. In addition, the received data analyzer 1102 determines the security level of the user of the MFP 1000.

In step S202, the JOB generator 1103 generates a JOB used to print the PDL data at the user level based on the print setting information set at the user level corresponding to the determined security level. For example, if the determined security level is “3”, since the corresponding user level is 1311, the JOB generator 1103 generates a JOB used to generate the print example 11003 shown in FIG. 10.

In this manner, the second embodiment generates only a JOB used to print PDL data for the user level corresponding to the security level of the user who operates the MFP unlike in the first embodiment.

In step S203, the PDL analyzer 1104 analyzes the generated PDL data and generates intermediate data in an easier-to-be-processed format. This intermediate data is temporarily stored in the data storage unit 1030, and is then printed.

As described above, according to the second embodiment, received print data can be printed to have print contents corresponding to the security level of the user who operates the MFP 1000.

### Third Embodiment

In the first and second embodiments, the host computer 1001 side generates all print data corresponding to different user levels, and transmits them to the MFP 1000, which appropriately processes the received print data as JOBs. However, the present invention is not limited to this. For example, the host computer 1001 may generate print data including print setting information according to each user level, and document data to which that print setting information is applied, and transmits it to the MFP 1000, which may generate a JOB according to the print setting information.

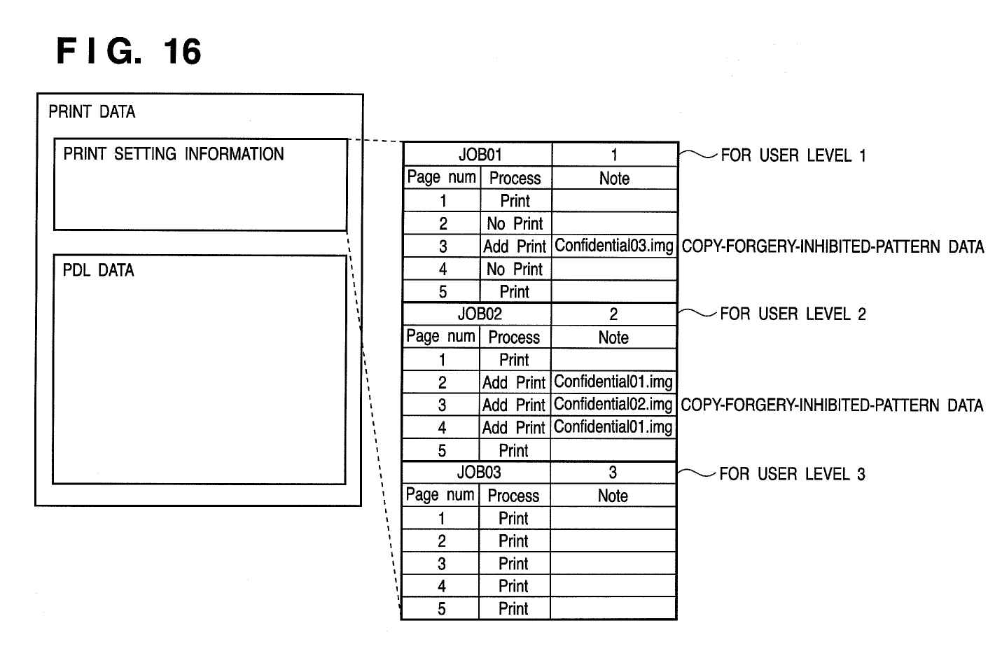

In this case, the host computer 1001 generates print data which includes only print setting information for each user level shown in FIG. 16 and PDL data corresponding to common document data to which the print setting information is applied. That is, the need for generating print data (print setting information and PDL data) corresponding to different user levels shown in FIG. 8 can be obviated.

Upon receiving the print data shown in FIG. 16, the MFP 1000 analyzes the contents of the print data, and executes the processing of the first or second embodiment based on the analysis result.

In case of the arrangement of the third embodiment, processing for adding copy-forgery-inhibited-pattern data (copy-forgery-inhibited-pattern-image) to document data in the received print data in accordance with the print setting information is executed. For example, the data storage unit 1030 in the MFP 1000 stores such copy-forgery-inhibited-pattern data, and the copy-forgery-inhibited-pattern data to be processed is specified in accordance with a file name designated by the print setting information.

Note that Japanese Patent Laid-Open No. 2005-111957 describes print processing (copy-forgery-inhibited-pattern print processing) including copy-forgery-inhibited-pattern data on the MFP 1000. Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the discloses exemplary embodiments. The scope of the following claims is to be accorded the broadest interpretations so as to encompass all such modifications and equivalent structures and functions.

This application claims the benefit of Japanese Patent Application No. 2005-321396 filed on Nov. 4, 2005, which is hereby incorporated by reference herein in its entirety.

What is claimed is:

1. An information processing apparatus for generating print data to be output to a printing apparatus, comprising:
setting means for setting a plurality of pieces of print setting information corresponding to a plurality of user types for identical document data;
generation means for generating a print job which includes the plurality of pieces of print setting information corresponding to the plurality of user types set by said setting means and print data based on the document data; and
output means for outputting the print job generated by said generation means so as to print it using the printing apparatus.

2. The apparatus according to claim 1, wherein said generation means generates a print job which includes print data corresponding to the plurality of user types obtained by applying the plurality of pieces of print setting information corresponding to the plurality of user types set by said setting means to the document data.

3. The apparatus according to claim 1, wherein said setting means comprises:
first setting means for setting groups to which pages that form the document data belong;
second setting means for setting processing contents of pages that belong to the groups set by said first setting means in correspondence with the plurality of user types; and
third setting means for setting the numbers of copies to be printed of the document data according to the processing contents set for the user types in correspondence with the plurality of user types.

4. The apparatus according to claim 3, further comprising display control means for controlling to display a print setting dialog including said first to third setting means on a display unit.

5. The apparatus according to claim 3, wherein the processing contents include a print method of one of a normal print mode, a copy-forgery-inhibited-pattern print mode, and a print inhibition mode, and the number of copies to be printed corresponding to each user type.

6. A printing apparatus for executing print processing based on print data received from an information processing apparatus, comprising:
reception means for receiving, from the information processing apparatus, print data in which a plurality of pieces of print setting information are set in correspondence with a plurality of user types; and
print control means for controlling to execute print processing in accordance with the print setting information set in the print data received by said reception means.

7. The apparatus according to claim 6, wherein the print data includes print data corresponding to the plurality of user types obtained by applying the plurality of pieces of print setting information to identical document data.

8. The apparatus according to claim 6, wherein said print control means controls to execute the print processing of the processing contents corresponding to each of the plurality of user types in accordance with the print setting information set in the print data received by said reception means.

9. The apparatus according to claim 6, further comprising:
input means for inputting identification information required to identify a user who operates said printing apparatus;
storage means for storing the print data without executing print processing until the identification information is input from said input means; and
determination means for determining a security level of the user based on the identification information input by said input means, and
in that said print control means executes, in accordance with the print setting information of the user type corresponding to the security level determined by said determination means of the plurality of pieces of print setting information set in the print data stored in said storage means, the print processing of the processing contents corresponding to the user type.

10. A printing system having an information processing apparatus for generating print data, and a printing apparatus for executing print processing based on the print data, wherein
setting means for setting a plurality of pieces of print setting information corresponding to a plurality of user types for identical document data;
generation means for generating a print job which includes the plurality of pieces of print setting information corresponding to the plurality of user types set by said setting means and print data based on the document data; and
output means for outputting the print job generated by said generation means so as to print it using the printing apparatus, and
said printing apparatus comprises:
reception means for receiving, from said information processing apparatus, the print data in which the plurality of pieces of print setting information are set in correspondence with the plurality of user types; and
print control means for controlling to execute print processing in accordance with the print setting information set in the print data received by said reception means.

11. A method of controlling an information processing apparatus for generating print data to be output to a printing apparatus, comprising:
a setting step of setting a plurality of pieces of print setting information corresponding to a plurality of user types for identical document data;
a generation step of generating a print job which includes the plurality of pieces of print setting information corresponding to the plurality of user types set in the setting step and print data based on the document data; and
an output step of outputting the print job generated in the generation step so as to print it using the printing apparatus.

12. A method of controlling a printing apparatus for executing print processing based on print data received from an information processing apparatus, comprising:
a reception step of receiving, from the information processing apparatus, print data in which a plurality of pieces of print setting information are set in correspondence with a plurality of user types; and
a print control step of controlling to execute print processing in accordance with the print setting information set in the print data received in the reception step.

13. A program stored in a computer-readable memory, for making a computer control an information processing apparatus for generating print data to be output to a printing apparatus, said program making the computer execute:
a setting step of setting a plurality of pieces of print setting information corresponding to a plurality of user types for identical document data;
a generation step of generating a print job which includes the plurality of pieces of print setting information corresponding to the plurality of user types set in the setting step and print data based on the document data; and
an output step of outputting the print job generated in the generation step so as to be printed using the printing apparatus.

14. A program stored in a computer-readable memory, for making a computer control a printing apparatus for executing print processing based on print data received from an information processing apparatus, said program characterized by making the computer execute:
a reception step of receiving, from the information processing apparatus, print data in which a plurality of pieces of print setting information are set in correspondence with a plurality of user types; and
a print control step of controlling to execute print processing in accordance with the print setting information set in the print data received in the reception step.
